(19) United States
(12) Patent Application Publication
(10) Pub. No.: US 2025/0207459 A1
(43) Pub. Date: Jun. 26, 2025

(54) CORDED SUNSHADE AND A GLAZING ELEMENT

(71) Applicant: Suomen Visor Oy, Kempele (FI)

(72) Inventors: Teuvo HAAPALAHTI, Oulunsalo (FI); Timo Juhani KOTAJÄRVI, Oulu (FI); Esa HILLIAHO, Valkeala (FI)

(21) Appl. No.: 18/987,160

(22) Filed: Dec. 19, 2024

(30) Foreign Application Priority Data
Dec. 21, 2023 (FI) 20236407

(51) Int. Cl. E06B 9/327; E06B 9/262

(52) U.S. Cl. CPC E06B 9/327; E06B 9/262; E06B 2009/2625

(57) ABSTRACT

The corded sunshade comprises a protective screen (10) having a first side edge (12) and a second side edge (14), a first end edge (16) and a second end edge (18), at least one a first cord (24) and at least one second cord (26) for supporting the protective screen. A first channel (30) is configured to enclose the cord section of the first cord extending outside the area covered by the protective screen and a second channel (32) is configured to enclose the cord section of the second cord extending outside the area covered by the protective screen. The corded sunshade further comprises at least one deviator for steering the cord section(s) into the first and second channels, which deviator comprises a holder for receiving and guiding the cords. A gap in the first and second channels is narrower than the width of the holder.

### CROSS-REFERENCE TO RELATED APPLICATION

This application claims priority of Finnish national patent application No. 20236407, filed on Dec. 21, 2023.

### TECHNICAL FIELD

The invention relates to a corded sunshade comprising a protective screen and a glazing element comprising a corded sunshade.

### BACKGROUND ART

Windows, glazed doors, and balcony glasses are often provided with sunshades to restrict the access of solar radiation into room spaces or into a balcony. Typically, the sunshades are either venetian blinds or so-called pleated blinds, featuring a folding protective screen which has its top edge provided with a first edge strip and its bottom edge with a second edge strip. The edge strips can be moved along supporting cords co-directional with the edges of a glazing element, thereby changing a shade-giving surface area of the protective screen between the edge strips. The edge strips are typically hollow aluminum profiles, which are closed at the ends thereof with plastic end plugs.

The number of supporting cords is usually at least two, such that the first cord is arranged to a first edge of the protective screen and the second cord to a second edge of the protective screen. The guiding cords are attached by a first end thereof to a first end side of the glazing element to be covered and by second end thereof to a second end side of the glazing element to be covered. In most cases the sunshades are placed in a way, that the cords extend co-directionally with vertical edges of the glazing element, whereby the edge strips moving along cords are in substantially horizontal position. However, it is sometimes possible to install the cords co-directional with horizontal edges of the glazing element, whereby the edge strips moving along guiding cords are in substantially vertical position. The cords support the protective screen by its edges and sustain the protective screen in a substantially single plane, in other words prevent deflection of the protective screen. As the width of a protective screen increases, the screen's mid-section is often provided with additional support cords which are tasked to support and guide a protective screen also at the protective screen's mid-section.

In order for the cords to cover as little as possible of glazed part of the glazing element, such as a window, a door or a balcony glazing, the cords are often adapted to extend in the closest possible proximity to the side edges of the glazing element. Such cords are conducted through the end plug of a first edge strip into the edge strip's interior, wherein the cord first runs over a short distance co-directionally with the edge strip, makes a right-angle turn towards a second edge strip and proceeds through holes in the pleats of a protective screen co-directionally with a side edge of the protective screen into the second edge strip's interior. In the second edge strip, the guiding cord's passage continues by way of a hole in the second edge strip's end plug outside of the edge strip, wherein it deflects again to extend alongside a side edge of the opening to be draped. The additional support cords of wide pleated blinds are conducted to extend into edge strips and out of edge strips through holes in the end plugs in a substantially identical manner. Some pleated blinds constructed in an aforementioned manner are disclosed in publications EP 3862527, EP 3530868 and DE 202022106449 U1.

A problem with the known pleated blinds is that when the sunshade does not cover the whole glazing element, i.e. the first edge strip is not next to the first edge of the glazing element and/or the second edge strip is not next to second edge of the glazing element, the cords are not covered or surrounded by any protective element. Instead, they run freely form the edge strip to the nearest edge of the glazing element. If the sunshade is in fully retracted position the length of the free cord may be significant depending on the size of the glazing. Typically, the cords are so close the floor level, that they create a risk especially for small children to stick to and in worse case to be strangled by the cords. This risk has been recognized in many countries, for example in Canada, where the length of the reachable cord is regulated in Corded Window Coverings Regulation: SOR/2019-97.

An object of the invention is to introduce a corded sunshade and a glazing element, which eliminate the safety problem relating to long reachable cords of the corded sunshades. The object of the invention is achieved with a corded sunshade and a glazing element, which are characterized by what is presented in the independent claims. Some preferred embodiments of the invention are presented in the dependent claims.

### SUMMARY OF THE INVENTION

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

The corded sunshade according to the invention comprises a protective screen having a first side edge and a second side edge, a first end edge and a second end edge, at least one first cord and at least one second cord for supporting the protective screen, which at least one first and second cords have at least one cord section extending outside the area covered by the protective screen, a first channel and a second channel configured to enclose the cord sections of the at least one first cord and the at least one second cord extending outside the area covered by the protective screen, which first and second channels locate outside the area bordered by the first and second side edges of the protective screen and which first and second channels have a first side and a second side defining a gap therebetween, which gap is narrower than the first channel and the second channel. The sunshade further comprises at least one deviator for steering the cord sections of the at least one first cord and the at least one second cord into the first and second channels respectively, which deviator comprises a holder for receiving and guiding the first and second cords, which holder is configured to prevent the first and second cords from escaping from the deviator. The gap in the first and second channels is narrower than the width of the holder of the deviator.

Some embodiments of the corded sunshade according to the invention further comprise a first edge strip at the first end edge of the protective screen, a second edge strip at the second end edge of the protective screen, the first and second edge strips having first and second ends and the at least one first and second cords are configured enter into the first edge strip, to travel from the first edge strip to the second edge strip and to exit from the second edge strip and the at least one deviator is arranged to the first and second ends of the first and second edge strips.

In some embodiments of the corded sunshade according to the invention the first and second edge strips comprise end plugs at their first and second ends and said deviator is integrated into said end plugs. Integration means here, that the deviator can be a separate component, which is connected to the end plug such, that the deviator and the end plug form a single component. Alternatively, the end plug including the deviator can formed directly to a single component.

Some embodiments of the corded sunshade further comprise a first fastening lath and a second fastening lath for attaching the corded sunshade to a glazing element, the first and second fastening laths having first and second ends, the first ends of the first and second cords extend inside the first fastening lath and the second ends of the first and second cords extend inside second fastening lath via said first and second ends and at least one deviator is arranged to the first and second ends of the first and second fastening laths.

In some embodiments of the corded sunshade according to the invention the first and second fastening laths comprise end pieces at their first and second ends and said deviator is integrated into said end pieces. Integration means here, that the deviator can be a separate component, which is connected to the end piece such, that the deviator and the end piece form a single component. Alternatively, the end piece including the deviator can formed directly to a single component.

In some embodiments of the corded sunshade according to the invention the deviator comprises a shaped metal wire. Preferably, the deviator further comprises at least one fixing leg for connecting the deviator to the end plug or to the end piece such, that the which fixing leg(s) and the holder are formed of a same piece of metal wire.

In some embodiments of the corded sunshade according to the invention the gap is at least partially covered by at least one deformable seal. Said at least one seal may be an integral part of the first and second channel. Alternatively, said at least one seal may be separate sealing element attached to the first and second channels.

Some embodiments of the corded sunshade according to the invention further comprise at least one steering element configured to steer the first and second cords out of the first and second channels. Preferably, said steering element is arranged to the first and/or second ends of the first and second channels.

In some embodiments of the corded sunshade according to the invention said first and second channels are made of transparent material.

The glazing element according to the invention comprises a transparent panel having a first end border and a second end border, a first side border and a second side border and further a corded sunshade according to the invention installed to said glazing element.

In some embodiments of the glazing element according to the invention the first channel is attached next to the first side border and the second channel is attached next to the second side border and the first and second channels extend from the first end border to the second end border of the transparent panel.

In some embodiments of the glazing element according to the invention the first and second channels open towards each other and the width of the protective screen is less than or equal to the clearance between first and second channels.

Some embodiments of the glazing element according to the invention further comprises first side profile at the first side border and a second side profile at the second side border of the transparent panel and the first and second channels are attached to the first and second side profiles or integrated into the first and second side profiles. Preferably the glazing element is a window, a door having a window or a terrace glazing element.

An advantage of the invention is, that it increases the safety of the corded sunshades by enclosing the uncovered cord sections, whereby they are no longer reachable. Thus, the risk to stick to and to be strangled by the cords is eliminated.

### BRIEF DESCRIPTION OF THE DRAWINGS

In the following the invention will be described in detail, by way of examples, with reference to the accompanying drawings in which,

FIG. 1 depicts an example of corded sunshade according to the invention installed to a balcony glazing,

FIG. 2a depicts a part of the corded sunshade shown in FIG. 1 seen from the front,

FIG. 2b depicts a part of the corded sunshade shown in FIGS. 1 and 2a seen from above,

FIGS. 3a to 3i depict details of the embodiments of the corded sunshade according to the invention,

FIG. 4a depicts an embodiment of the glazing element according to the invention,

FIG. 4b depicts a partial cross-section of the embodiment shown in FIG. 4a,

FIG. 4c depicts a fastener for attaching the first and second channels to the frame of the glazing element and

FIG. 4d depicts another embodiment of the glazing element according to the invention.

### DETAILED DESCRIPTION

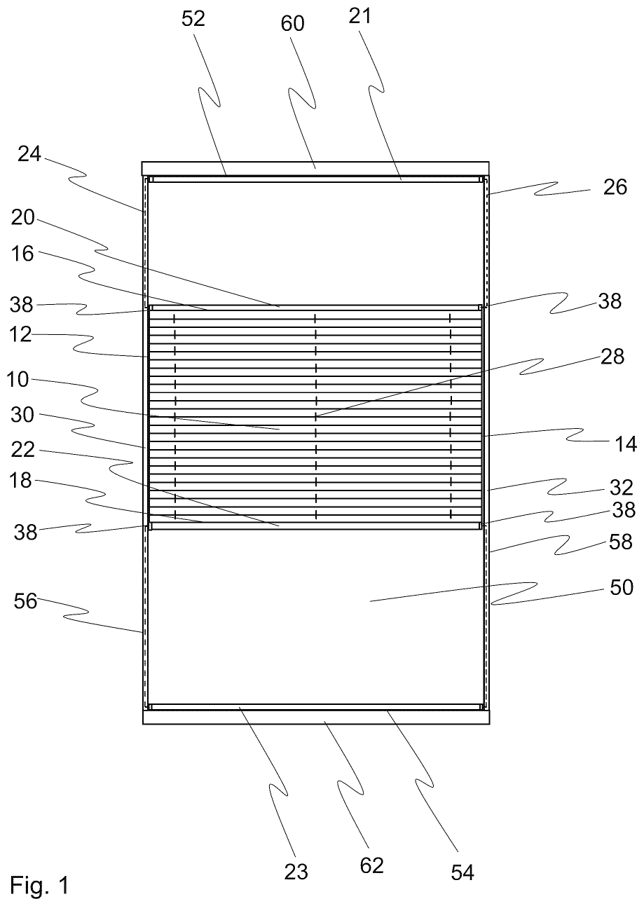

In FIG. 1 an example of a corded sunshade according to the invention installed to a known balcony glazing is shown. The balcony glazing comprises a rectangular transparent panel 50, preferably a glass panel, having a first end border 52 and a second end border 54, a first side border 56 and a second side border 58. The first and second end borders are provided with upper and lower frame profiles 60, 62 fixedly attached to the first and second end borders. The upper and lower frame profiles are preferably aluminum profiles.

The corded sunshade installed to the balcony glazing comprises a rectangular protective screen 10, which is made of pleated fabric having reduced light transmission ability. The ability of the protective screen to transmit visible light may so low, that the protective screen may act as a blackout curtain. The protective screen has a first side edge 12 and a second side edge 14, a first end edge 16 and a second end edge 18. The first and second end edges are provided with first and second edge strips 20, 22, which are preferably hollow aluminum profiles. The ends of the first and second edge strips 20, 22 are furnished with end plugs 38, which are preferably made of plastic. The sunshade further comprises two first cords 24 and a two second cords 26 supporting and guiding the protective screen 10 and first and second fastening laths 21, 23 for attaching the corded sunshade to the balcony glazing. The first ends of the first and second cords extend inside the first fastening lath and the second ends of the first and second cords extend inside second fastening lath. Inside the first and second fastening laths there are spring biased locking means to which the ends of the first and second cords are secured. The first fastening lath 21 is attached next to the upper frame profile 60 and a second fastening lath 23 is attached next to the lower frame profile 62. The fastening laths are attached to the frame profiles or to the side borders of the transparent panel with suitable fastening means.

The first cords exit from the first end of the first fastening lath, travel alongside the first side border of the transparent panel and enter into the first edge strip 20 through the end plug 38. Correspondingly, the second cords exit from the second end of the first fastening lath, travel alongside the second side border of the transparent panel and enter into the first edge strip 20 through the end plug. From the first edge strip the first and second cords travel through holes in the protective screen 10 to the second edge strip 22. When travelling from the first edge strip to the second edge strip, the first and second cords naturally stay between the first and second side edges 12, 14 of the protective screen. The first cords and second cords exit from the ends of the second edge strip 22 through end plugs 38, travel alongside the side borders of the transparent panel and enter into the second fastening lath 23 through the ends thereof.

When the protective screen is not in fully outspreaded position, i.e. when there is a clear gap between the first edge strip 20 and the first fastening lath 21 and/or between the second edge strip 22 and the first fastening lath 23, the first and/or second cords 24, 26 have at least one cord section extending outside the area covered by the protective screen. The corded sunshine according to the invention further comprises a first channel 30 at the first side border 56 of the transparent panel and a second channel 32 at the second side border 56 of the transparent panel. The first and second channels extend from the lower frame profile 62 to the upper frame profile 60 and they locate outside the area bordered by the first and second side edges of the protective screen. The sections of the first and second cords extending outside the area covered by the protective screen are steered into the first or second channels. Thus, the sections of first and second cords between first edge strip 20 and the first fastening lath 21 and/or between the second edge strip 22 and the first fastening lath 23 are enclosed by the first or second channels.

The corded sunshade may further comprise one or more third cords 28 for supporting the middle part of the protective screen. The ends of the third cords are attached to first and second fastening laths 21, 23 and the cord sections of the third cord(s) extending outside the area covered by the protective screen are steered into the first or second channel in a similar manner as the first and second cords. The number of the thirds cords depends on the width of the protective screen. Usually, the number of third cords is two or four. When the corded sunshade contains two third cords 28 both third cords may run through a single row of holes in the middle part of the protective screen or through two rows of holes each row encompassing only one third cord. When the corded sunshade contains four third cords 28 there may be two rows of holes each row encompassing two third cords or there may be four rows of holes each row encompassing only one third cord. The distance between adjacent rows of holes is preferably equal.

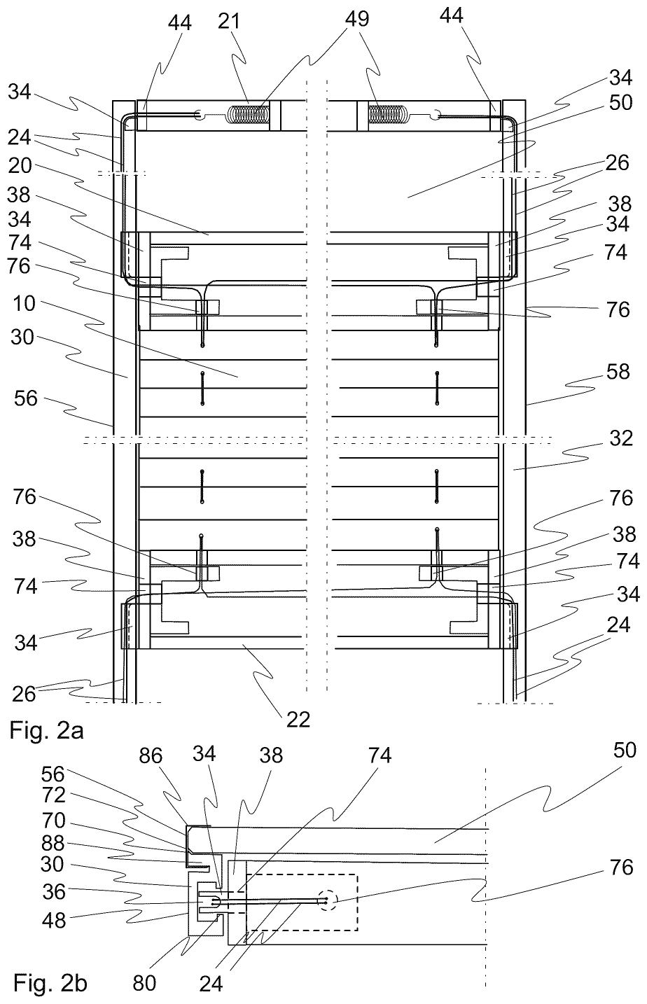

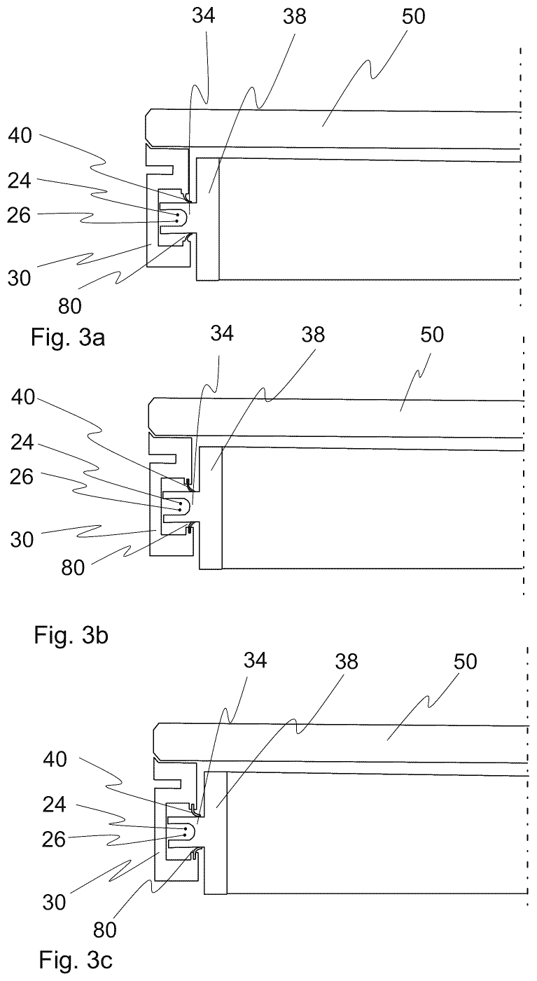

In FIG. 2a a part of the corded sunshade depicted FIG. 1 is shown from the front and in FIG. 2b a part of the corded sunshade depicted in FIGS. 1 and 2a is shown as a horizontal cross-section. In FIG. 2a the first and second edge strips 20, 22 and the first fastening lath 21 are presented as vertical cross-sections. FIG. 2b shows only the first border 56 of the transparent panel 50 and the first end on the first edge strip. The second border of the transparent panel and the second end of the first edge strip are mirror images of FIG. 2a.

The first and second channels 30, 32 are attached to the first and second side borders 56, 58 of the transparent panel 50 in a way, that the channels on the opposing sides of the transparent panel open towards each other and the rear surfaces 48 of the channels lie flush with the side border of the transparent panel. On the side surface 49 facing the transparent panel 50 there may be a rim 70 having a triangular cross-section with matching dimensions with a bevel 72 on the side borders of the of the transparent panel. The rim helps to place the first and second channels flush with the side border of the transparent pane (FIG. 2b). The first and second channels are made of substantially transparent material, such as suitable plastic composition. The channels are attached to the transparent panel preferably by clips 86 clamping the flange 88 on the side of the channels and the side border of the transparent panel together. The clips may be made of shaped metal strip or of shaped metal wire acting as spring biased clamping elements. Preferably the clips are made of stainless steel. The distance between adjacent clips can be selected based on the rigidity of the first and second channels. Preferably the clearance between adjacent clips is provided with two-sided adhesive tape, fixing the facing surfaces of the flange and the transparent panel together by adhesive force.

The ends of the first fastening lath 21 are provided with end pieces 44, having an aperture, through which the first ends of the two first cords 24 and two second cords 26 enter inside the first fastening lath. The first ends of the cords are secured to the spring biased fastening elements 49 inside the first fastening lath. The second ends of the first and second cords are attached to the second fastening lath (not shown) in a corresponding manner.

The first and second ends of the first and second edge strips 20, 22 are provided with end plugs 38 having a head part remaining outside the edge strip and a tail part extending into the hollow interior of the edge strip. The end plugs have a first hole 74 configured to receive first and/or second cords entering inside the edge strip and a second hole 76 configured to steer the first and/or second cords leaving the edge strip towards the edge strip on the opposing end edge of the protective screen.

The first cords exit the first fastening lath 21, enter into the first channel 30, extend inside the first channel towards the first edge strip 20 and enter inside the first edge strip through the first holes 74 in the end plugs 38 at the first end of the first edge strip. Correspondingly, the second cords 26 exit from the first fastening lath 21, enter into the second channel 32, extend inside the second channel towards the first edge strip 20 and enter into the first edge strip through first holes 74 in the end plugs 38 at the second end of the first edge strip. The first cords leave the first edge strip through second holes 74 of the end plugs, travel through series of small holes in the pleated protective screen and enter into the second edge strip through second holes 76 of the ends plugs of the second edge strip. The first cords exit the second edge strip through first holes 74 in the second end of the second end strip and are steered into the second channel 32, inside which they stay until entering into the second fastening lath (not shown). Correspondingly the second cords 26 exit the second edge strip through first holes 74 in the first end of the second end strip and are steered into the first channel 30, inside which they stay until entering into the second fastening lath (not shown).

The end plugs 38 comprise a deviator 34 configured to steer the first or second cord 24, 26 protruding through the first hole 74 out of the first or second edge strip into the first or second channel 30, 32. The deviator is a bracket extending from the outer surface of the head part of the end plug 38 into the channel. The width of the deviator is less than the width of the gap 80 of the channels. On the outer edge of the deviator there is groove 36, for receiving and guiding the first and second cords (FIG. 2b). The the edges of the groove extend towards and near the bottom of the first and second channels and act as a holder, which prevent the cords from escaping from the groove. The end pieces 42 in the ends of the first and second fastening laths 21, 23 are furnished with corresponding grooved deviators 34 for steering the first and second cords protruding out of the fastening laths into the first or second channel 30, 32. The deviators steer the first and second cords to travel near the bottom of the first and second channel, whereby the cords cannot be reached or grasped by fingers.

The width of the gap 80 is so small, that in practise the straight, lightly tensioned cords inside channels cannot be reached by fingers. Preferably the width of the gap in the first and second channels is less than or equal to 6.35 mm to fulfil the Canadian Corded Window Coverings Regulation: SOR/2019-97.

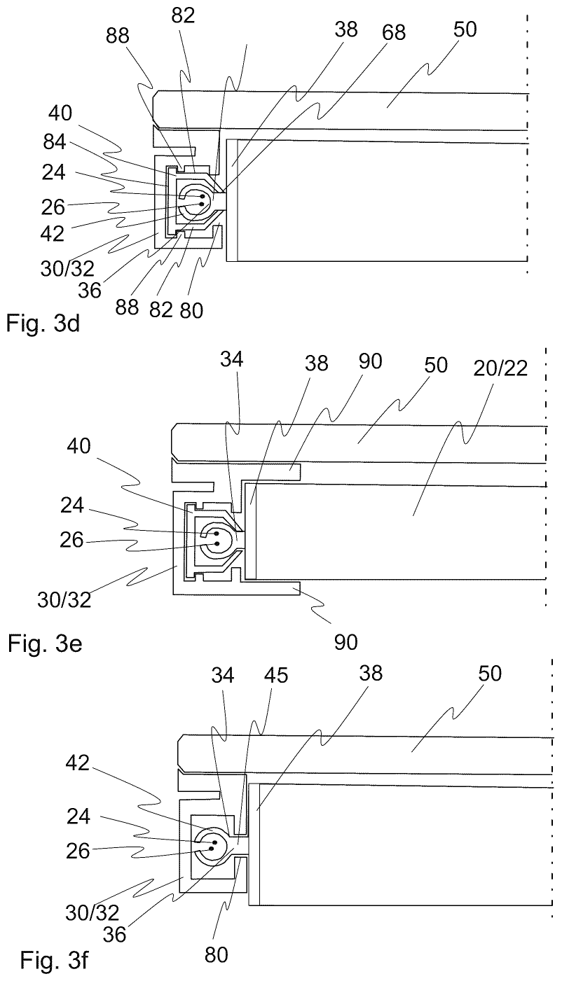

In FIGS. 3a, to 3d details of some preferred embodiments of the corded sunshade according to the invention are show as horizontal cross sections. In all of these embodiments the first and second channels 30, 32 comprise deformable seals 40 on both edges of the gap 80, into which the deviator 34 projects. In normal operation situations of the corded sunshade the first and second cords are tensioned, whereby they stay straight and do not try to leave from the first and second channels. However, in some situation the first or second cords may become loose, whereby they form loops trying to escape out the channels. This kind of situation may occur for example when the cord snaps or the fastening element slides inside the fastening lath. To prevent the loose cords from escaping from the channels, the edges of the gap 80 are furnished with deformable seals 40, which at least partially, preferably fully close those sections of the gap, where there is no deviator.

In FIG. 3a the seals are thin lips which are integral parts of the channel, which is made of a deformable plastic composition. In FIG. 3b the seals 40 are so called brush-seals, comprising a brush-like element on both sides of the gap. In FIG. 3c the seals are separate deformable strips, placed on slots on both sides of the gap. In all embodiments the seals extend from the first end of the channel to the second end of the channel. When no external force is acting on the seals, they close the gap at least partially, preferably substantially wholly, and prevent the loose first and second cords 24, 26 from escaping from the channel. However, the deformable seals allow the deviator 34 to enter and steer the first and second cords 24, 26 protruding through the end plug 38 and gap into the channel. The seals also allow the movement of the first and second edge strips in the direction of the first and second channels without significantly hindering the movement.

In FIG. 3d the seal 40 is a separate element in form of a chute, which is placed inside the first and second channels 30, 32. The seal has a slit 68 opening towards the gap 80. When there is no deviator 34 in the slit, the edges of the slit press against each other and the slit is practically fully closed. When the deviator enters into the slit, the edges of the slit spread apart leaving room for the deviator. Those sections of the slit, which are not occupied by a deviator remain closed. In the opened section of the slit the edges of the slit press against the deviator, whereby the width of the slit and the width and the deviator are equal. Thus, in all situations the width of the slit is smaller than the width of the gap 80. Preferably, the seal and the first and second channels 30, 32 are made of different materials.

The chute-like seal comprises a bottom 84 and side walls 82 connecting the bottom 84 and the edges of the slit 60. In the inner surface of the first and second channel there are two lugs 88 holding the bottom 84 in place near the rearward surface of the channel. The side walls are less rigid than the bottom and the edges of the slit, whereby the deformation of the chute enabling the opening of the slit occurs mainly in the side walls and to a lesser extent in the edges of the slit and in the bottom. This makes possible to make the edges relatively hard and rigid, whereby the friction between the deviator and the edges of the slit is low. Adjusting the rigidity of the different parts of the chute can be implemented by changing the wall thickness of the chute and/or by changing the material properties in different parts of the chute.

In the embodiment shown in 3d the deviator 34 has a holder 42 configured to prevent the first and second cords 24, 26 from escaping from the groove 36. The holder is formed by shaping the edges of the groove into a two arc-shaped walls surrounding the groove from both sides. Between the free ends of the arc-shaped walls there is a small slot, through which the first and second cords 24, 26 can enter into the groove 36. The slot can be straight or curved and it can be in parallel or in inclined position in relation to the longitudinal direction of the first and second channels.

The deviator is placed into the chute-like seal 40 during installation of the corded sunshade. The deviator and especially the wider holder 42 of it can be slided into the seal from the open ends of the seal. Alternatively, the seal can be shorter than the channel leaving a section or sections without seal to the ends of the channel, through which the holder 42 of the deviator can first enter into the channel in transverse direction and further into the seal in longitudinal direction of the channel.

FIG. 3e shows an embodiment of the corded sunshade according to the invention as horizontal cross sections, where the first and second channels 30, 32 comprise side extensions 90 extending from the surface of the channel closest to the end plug 38. The clearance between the side extensions is slightly bigger than the width of the first and second edge strips 20, 22, whereby the first and second ends of the first and second edge strips can enter between the side extensions. In this embodiment the gap 80 through which the deviator 34 steers the first and second cords 24,26 into the first and second channels is apart from the free edges of the side extensions. The first and second side edges of the protective screen are overlapped by the side extensions, whereby light cannot pass through the seam between the side edges of the protective screen and the channels. Therefore, this embodiment is especially suitable for blackout curtains.

FIG. 3f shows an embodiment of the corded sunshade according to the invention as horizontal cross sections. Also in this embodiment the deviator 34 has a holder 42 configured to prevent the first and second cords 24, 26 from escaping from the groove 36. The holder is formed by shaping the edges of the groove into a two arc-shaped walls surrounding the groove from both sides. Between the free ends of the arc-shaped walls there is a small slot, through which the first and second cords 24, 26 can enter into the groove 36. The slot can be straight or curved and it can be in parallel or in inclined position in relation to the longitudinal direction of the first and second channels. In this embodiment the gap 80 in the first and second channels 30, 32 is significantly narrower than the width of the holder 42 of the deviator 34. The width of the gap is only slightly wider than the width of the thin neck part 45 of the deviator bordered by the edges of the gap. The gap can be less than 2 mm, preferably less than 1.5 mm wide. In this embodiment the first and second channels 30, 32 may have seals on the edges of the gap as shown in FIGS. 3a to 3c. To help the place the holders 42 of the deviators inside the channel in the installation phase of the corded sunshade, the gap may have at least one enlargement section (not shown) having a width and length corresponding the width and length of the holder 42. Preferably, in the enlargement section the width of the gap is still less than 6.35 mm to fulfil the requirements of SOR/2018-97. The holder can enter into the channel through the enlargement section whereafter the deviator can move along the channel. Preferably the enlargement section(s) locate near the ends and/or the middle sections of the channels. Alternatively, the deviator and especially the wider holder 42 of it can be slided into the channels from the open ends of the channels. The embodiment shown in FIG. 3f may contain the side extensions 90 extending from the surface of the channel closest to the end plug 38 is as shown in FIG. 3e.

In FIG. 3g a detail of one preferred embodiment of the corded sunshade according to the invention is shown as a vertical cross section. In this embodiment the ends of the first and second channels 30, 32 are furnished with steering elements 78 for steering the first and second cords 24, 26 into the first and second fastening laths 21, 23 through holes in the end pieces 44. The steering element comprises a curved duct 79 with a first end opening into the channel and a second end opening to the side of channel facing the end piece 44 of the fastening lath. In this embodiment the steering element replaces the deviator in the end piece, i.e. the end pieces need no deviator.

In FIG. 3h a detail of one preferred embodiment of the corded sunshade according to the invention is shown diagonally from above. In this embodiment the deviator 34 is formed of a single, shaped metal wire piece. The diameter of the metals wire can be 0.8-1.2 mm, preferably 0.9 mm. The deviator has a holder 42 in the first end, a fixing leg 43 in the second end, and a neck part 45 connecting the holder and the fixing leg. The holder has a shape of a short helical spring. The neck part 45 of the deviator comprises a substantially straight section of the metal wire and at the end of the fixing leg of the metal wire is folded in parallel. The diameter of the holder is dimensioned such, that the holder loosely surrounds all the cords 24, 26 traveling through the holder 42. In the embodiment of FIG. 3h two cords are shown, but the number of cords can be bigger, such as three or four. The inner diameter of the holder can be 2-6 mm. Thus, the holder is significantly wider, than the neck part of the deviator, which comprises only a single metal wire. Since the width of gap in the first and second channels needs to be only slightly wider than the width of the neck part 45, the gap can be very narrow. The deviator is integrated into the end plug 38 of the first and second edge strips 20, 22 by inserting the fixing leg into a hole in the end plug. FIG. 3h shows the deviator both as a separate part and as integrated into the end plug. The deviator and the end plug with integrated deviator can be used in any corded sunshade according to the invention.

In FIG. 3i another detail of one preferred embodiment of the corded sunshade according to the invention is shown diagonally from above. Also in this embodiment the deviator 34 is formed of a single, shaped metal wire piece. The diameter of the metals wire can be 0.8-1.2 mm, preferably 0.9 mm. The deviator has a holder 42 in the first end, two fixing legs 43 in the second end, and a neck part 45 connecting the holder and the fixing legs. The holder has a shape of a loop. The inner diameter of the loop can be 2-6 mm. The neck part 45 of the deviator comprises a substantially straight section of two parallel metal wires and at the end of the neck part the fixing legs spread apart. The diameter of the loop-shaped holder is dimensioned such, that holder loosely surrounds all the cords 24, 26 traveling through the holder 42. The deviator is integrated into the end piece 44 of the first and second fastening laths 21, 23 by inserting the fixing legs into holes in the end piece. FIG. 3i shows the deviator both as a separate part and as integrated into the end piece. The deviator and the end piece with integrated deviator can be used in any corded sunshade according to the invention.

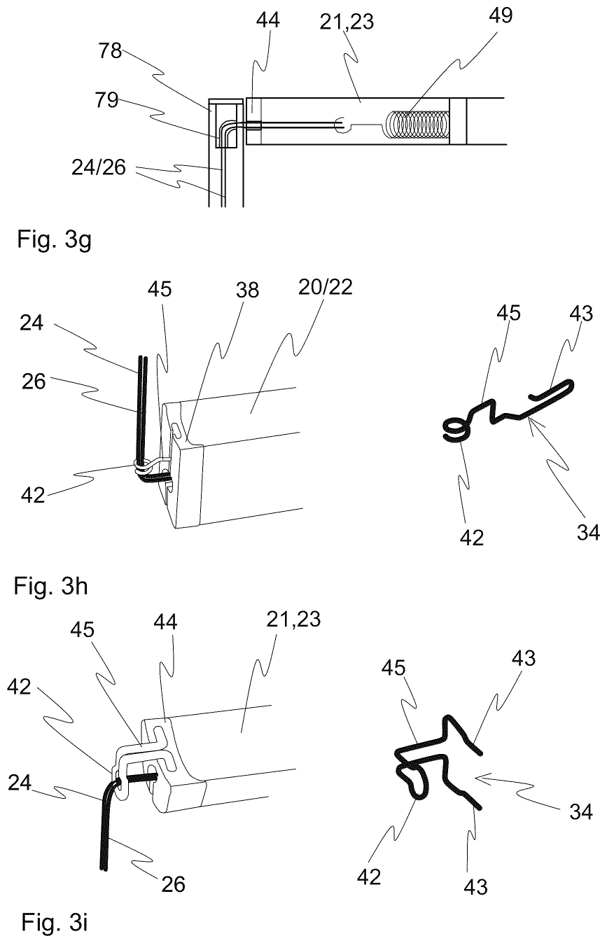

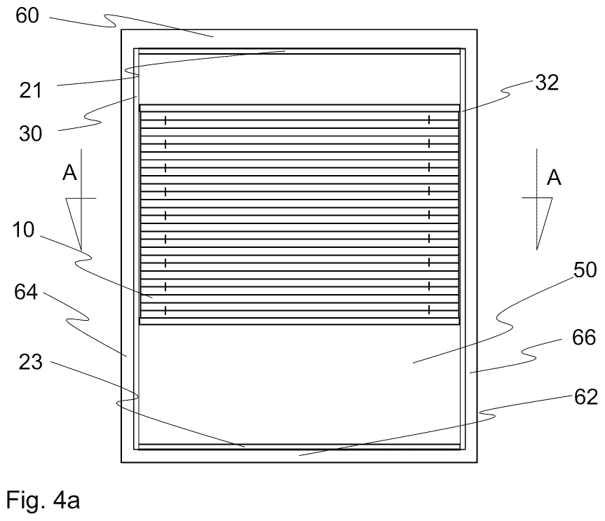

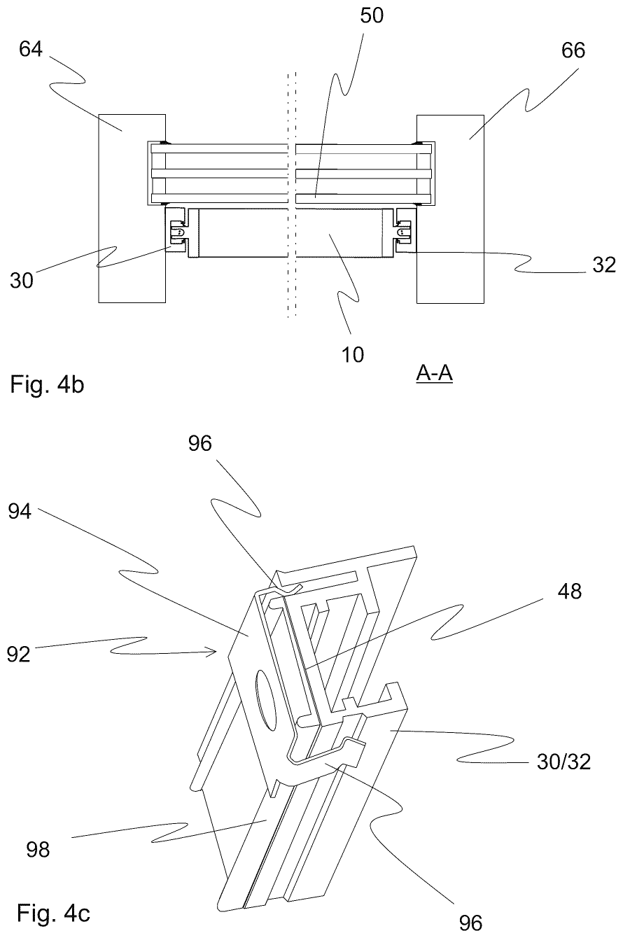

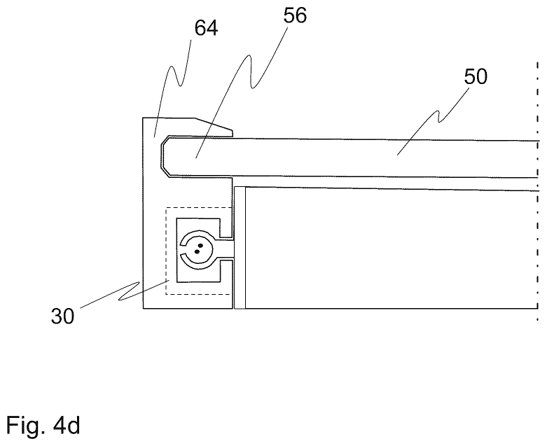

FIG. 4a shows an embodiment of the glazing element according to the invention and FIG. 4b depicts a partial cross-section of the same embodiment. The glazing element shown in the figures is a window comprising a multiple glass unit having three glass panels and a frame surrounding the multiple glass unit. The frame has an upper profile 60, a lower profile 62, first side profile 64 and second side profile 66. The profiles of the frame can be made of wood, metal, plastic or composite material. The glass panels of the multiple glass unit are transparent panels 50.

A corded sunshade comprising a protective screen 10 is installed to the window by attaching the first fastening lath 21 to the upper profile 60 and second fastening lath 23 to the lower profile 62 with suitable fastening means. The first channel 30 is arranged next to the first vertical edge, i.e. the first side border, of the innermost glass panel and the second channel 32 is arranged next to the second vertical edge, i.e. the second side border, of the innermost glass panel. The first and second channels are attached to the first and second side profiles 64, 66 of the frame of the window. Thus, the first and second channels are not attached directly to the transparent panel, but to the side profiles surrounding the transparent panel. In this embodiment the first and second channels and the frame profiles preferably have the same colour.

FIG. 4c depicts a fastener 92 for attaching the first and second channels 30, 32 to the side profiles of the frame of the glazing element. The fastener is a shaped metal sheet piece comprising a base 94 and two bands 96 on the opposing sides of the base. The base has a hole for attaching the fastener into the side profile by fixing screws. The base and the bands form a U-shaped slot, into which the first or second channel can be presses. The clearance between the bands is dimensioned to clamp and hold the channel between the bands tightly in place. Preferably, the rear surface 48 of the channel is furnished with a gasket strip 98 to make the seal between the channel and the side profile lightproof. The gasket strip has bossed edges facing the base of the fastener creating space for the heads of the fixing screws. Alternatively, the rear surface of the channel may have groove (not shown) extending in the longitudinal direction of the channel for receiving the heads of the fixing screws.

FIG. 4d shows a part of the vertical edge of another embodiment of the glazing element according to the invention as a horizontal cross-section. The glazing element shown in the figures may be balcony glazing or terrace glazing comprising a single transparent panel 50. The glazing element has an upper profile and a lower profile (not shown) as in the balcony glazing shown in FIG. 1. The embodiment further comprises at least a first side profile 64 shown in FIG. 4d and possibly also a second side profile. The side profiles can be made metal, plastic or composite material. Preferably the side profiles are made of aluminium. The first side profile comprises a fastening groove 65 enclosing and attaching to the first side border 56 of the transparent panel 50. The second side profile, if included in the embodiment, is arranged to the second side border of the transparent panel in a similar manner. The side profiles are useful especially in high glazing elements, such as balcony glazing, where they increase the rigidity and bending resistance of the element. The side profiles can be grasped simply by hand allowing easy moving of the glazing element sideways along upper and lower guide rails.

In this embodiment the first channel 30 is integrated in to the first side profile 64 and the second channel is integrated into the second side profile 66, whereby no separate channels are needed. The integrated channels may include any features of the corded sunshade disclosed in embodiment in FIGS. 2a, 2b and 3a-3f. Alternatively, the glazing element may comprise first side profile with integrated first channel arranged to the first side border 56 of the transparent panel 50 and a second channel according to the invention arranged to the second side border of the transparent panel.

Some preferred embodiments of the invention have been disclosed above. The invention is not limited to the solutions explained above, but the invention can be applied in different ways within the limits set by the patent claims.

Reference Signs:

| | |
|---|---|
| 10 | protective screen |
| 12 | first side edge |
| 14 | second side edge |
| 16 | first end edge |
| 18 | second end edge |
| 20 | first edge strip |
| 21 | first fastening lath |
| 22 | second edge strip |
| 23 | second fastening lath |
| 24 | first cord |
| 26 | second cord |
| 28 | third cord |
| 30 | first channel |
| 32 | second channel |
| 34 | deviator |
| 36 | groove |
| 38 | end plug |
| 40 | seal |
| 42 | holder |
| 43 | fixing leg |
| 44 | end piece |
| 45 | neck part |
| 46 | side surface |
| 48 | rear surface |
| 49 | fastening element |
| 50 | transparent panel |
| 52 | first end border |
| 54 | second end border |
| 56 | first side border |
| 58 | second side border |
| 60 | upper profile |
| 62 | lower profile |
| 64 | first side profile |
| 65 | fastening groove |
| 66 | second side profile |
| 68 | slit |
| 70 | rim |
| 72 | bevel |
| 74 | first hole |
| 76 | second hole |
| 78 | steering element |
| 79 | duct |
| 80 | gap |
| 82 | side wall |
| 84 | bottom |
| 86 | clip |
| 88 | lug |
| 90 | side extension |
| 92 | fastener |
| 94 | base |
| 96 | band |
| 98 | gasket strip |

1. A corded sunshade comprising
a protective screen having
a first side edge and a second side edge,
a first end edge and a second end edge,
at least one first cord and at least one second cord for supporting the protective screen, which at least one first and second cords have at least one cord section extending outside the area covered by the protective screen,
a first channel and a second channel configured to enclose the cord sections of the at least one first cord and the at least one second cord extending outside the area covered by the protective screen,
which first and second channels locate outside the area bordered by the first and second side edges of the protective screen, and
which first and second channels have a first side and a second side defining a gap therebetween, which gap is narrower than the first channel and the second channel, and
at least one deviator for steering the cord section(s) of the at least one first cord and the at least one second cord into the first and second channels respectively,
which deviator comprises a holder for receiving and guiding the first and second cords, which holder is configured to prevent the first and second cords from escaping from the deviator,
wherein the gap in the first and second channels is narrower than the width of the holder of the deviator.

2. The corded sunshade according to claim 1, wherein the sunshade further comprises
a first edge strip at the first end edge of the protective screen,
a second edge strip at the second end edge of the protective screen,
the first and second edge strips having first and second ends and the at least one first and second cords are configured to enter into the first edge strip, to travel from the first edge strip to the second edge strip and to exit from the second edge strip (22) and
the at least one deviator is arranged to the first and second ends of the first and second edge strips.

3. The corded sunshade according to claim 2 wherein the first and second edge strips comprise end plugs at their first and second ends and said deviator is integrated into said end plugs.

4. The corded sunshade according to claim 1 wherein the sunshade further comprises a first fastening lath and a second fastening lath for attaching the corded sunshade to a glazing element, the first and second fastening laths having first and second ends, the first ends of the first and second cords extend inside the first fastening lath and the second ends of the first and second cords extend inside second fastening lath via said first and second ends and at least one deviator is arranged to the first and second ends of the first and second fastening laths.

5. The corded sunshade according to claim 4 wherein the first and second fastening laths comprise end pieces at their first and second ends and said deviator is integrated into said end pieces.

6. The corded sunshade according to claim 1, wherein the deviator comprises a shaped metal wire.

7. The corded sunshade according to claim 1, wherein said gap is at least partially covered by at least one deformable seal.

8. The corded sunshade according to claim 7, wherein said at least one seal is an integral part of the first and second channel or said at least one seal is a separate sealing element attached to the first and second channels.

9. The corded sunshade according to claim 1 further comprising at least one steering element configured to steer the at least one first and second cords out of the first and second channels.

10. The corded sunshade according to claim 9, wherein said steering element is arranged to the first and/or second ends of the first and second channels.

11. The corded sunshade according to claim 1, wherein said first and second channels are made of transparent material.

12. A glazing element comprising a transparent panel comprising a first end border and a second end border, a first side border and a second side border and a corded sunshade according to claim 1 installed to said glazing element.

13. The glazing element according to claim 12, wherein the first channel is attached next to the first side border and the second channel is attached next to the second side border and the first and second channels extend from the first end border to the second end border of the transparent panel.

14. The glazing element according to claim 12, wherein the first and second channels open towards each other and the width of the protective screen is less than or equal to the clearance between first and second channels.

15. The glazing element according to claim 12 further comprising a first side profile at the first side border and a second side profile at the second side border of the transparent panel and the first and second channels are attached to the first and second side profiles or integrated into the first and second side profiles.

16. The glazing element according to claim 12, wherein said glazing element is a window, a door having a window or a terrace glazing element.
